(19) United States
(12) Patent Application Publication
(10) Pub. No.: US 2005/0086159 A1
(43) Pub. Date: Apr. 21, 2005

(54) Retail identification system

(76) Inventors: Noorallah Laiwalla, Milpitas, CA (US); Robert Eugene Cosaro, San Jose, CA (US); Daniel Patrick Tiemey, Mountain View, CA (US)

Correspondence Address: Daniel P. Tierney, 17 Moon Beam Dr., Mountain View, CA, 94043, US

(21) Appl. No.: 10/689,181

(22) Filed: Oct. 20, 2003

(51) Int. Cl. G06F 17/60

(52) U.S. Cl. 705/39

(57) ABSTRACT

This invention is used to collect information about the identity of a person for check cashing and age verification purposes. The source of this information will come from a driver license, check information, thumb print, photograph, phone number, and other user inputs.

### CROSS REFERENCE TO RELATED APPLICATIONS

Not Applicable.

### FEDERAL RESEARCH STATEMENT

Not Applicable.

### BACKGROUND OF INVENTION

If a patron attempts to write a check to a retail establishment, there currently does not exist an electronic method to associate driver license, photograph, thumb print, telephone number, and other identification to said check. In addition, when a customer purchases age-restricted retail products, the cashier is required by law to verify the patron's age.

The Retail Identification System invention utilizes various identification medium, such as, driver license, customer digital photograph, telephone number, thumb print, and other pieces of identification to electronically correlate with customer checks. This invention can also, verify customer age, using the driver license, to evaluate if the customer is of legal age to buy age-restricted retail products, such as alcohol, tobacco, and magazines.

### SUMMARY OF INVENTION

The Retail Identification System will be used to collect information about the identity of a person for check cashing and age verification. The source of this information will come from a driver's license, state ID card, check information, credit cards, or other inputs. The purpose of this system is to provide a scaleable data collection device that can be used by store owners to assist them in identifying their patrons. The system can also act as the stores time keeping device. The system can act stand-alone or can interface with a computer for data collection and analysis.

### BRIEF DESCRIPTION OF DRAWINGS

The detail operation of this invention can be understood in the following drawings:

FIG. 1. The system is composed of the data hub and peripherals. The peripherals will consists of third party devices that will be connected to the data hub. This figure illustrates the system overview.

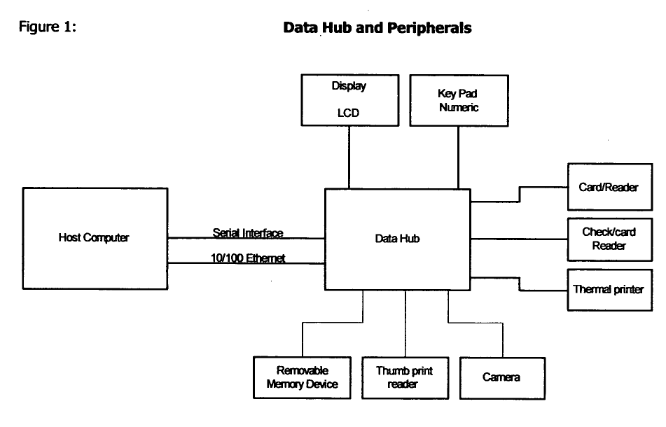

FIG. 2. The data hub is the central part of the information collection system. This figure illustrates the interfaces for the data hub.

FIG. 3. This figure illustrates the central verification database.

FIG. 4. This figure illustrates the check verification tree with check read first.

FIG. 5. This figure illustrates the check verification tree with ID read first.

### DETAILED DESCRIPTION

The smallest useful system consists of an interface to a magnetic card reader that is able to reads any magnetically coded driver's license. Once the data is read, the system will display the age of the patron and indicate whether or not the patron is old enough to buy either alcohol, tobacco, magazines, or other age restricted retail items. A character type LCD will display this information and will not require connection to a computer. The system is configurable to include a card reader for a drivers licenses, display, check reader, keypad, thumb print reader, camera, modem, multiple serial interface, a printer, and a Ethernet connection to a host computer. In this system the device will be able to store driver's license, check information, telephone numbers in nonvolatile memory until down loaded to a variety of peripherals. The system is controlled using an embedded processor with reprogrammable software.

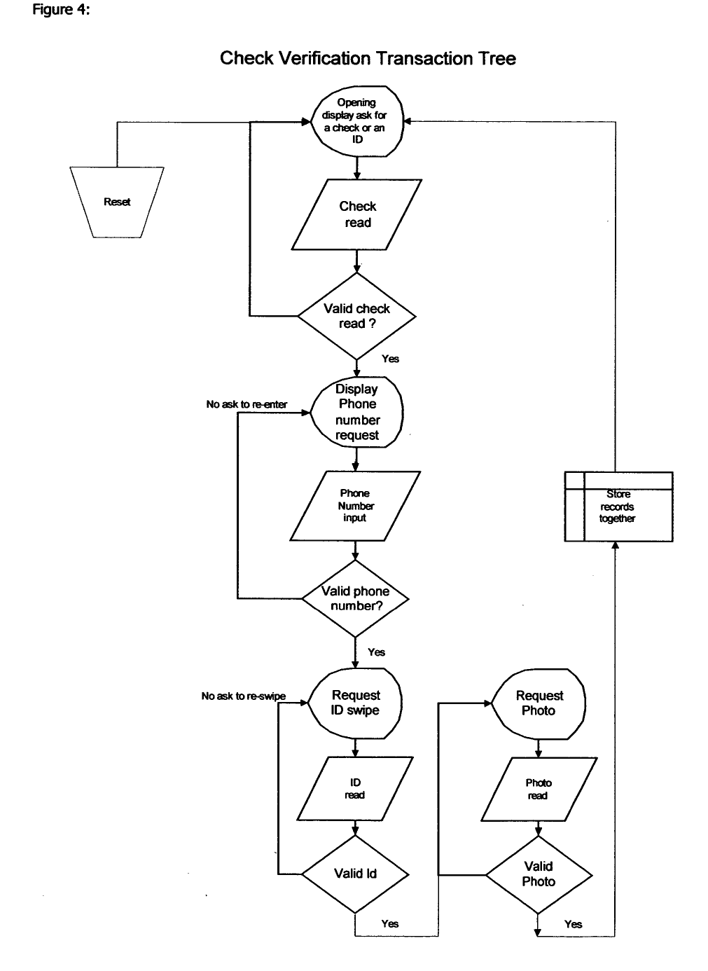

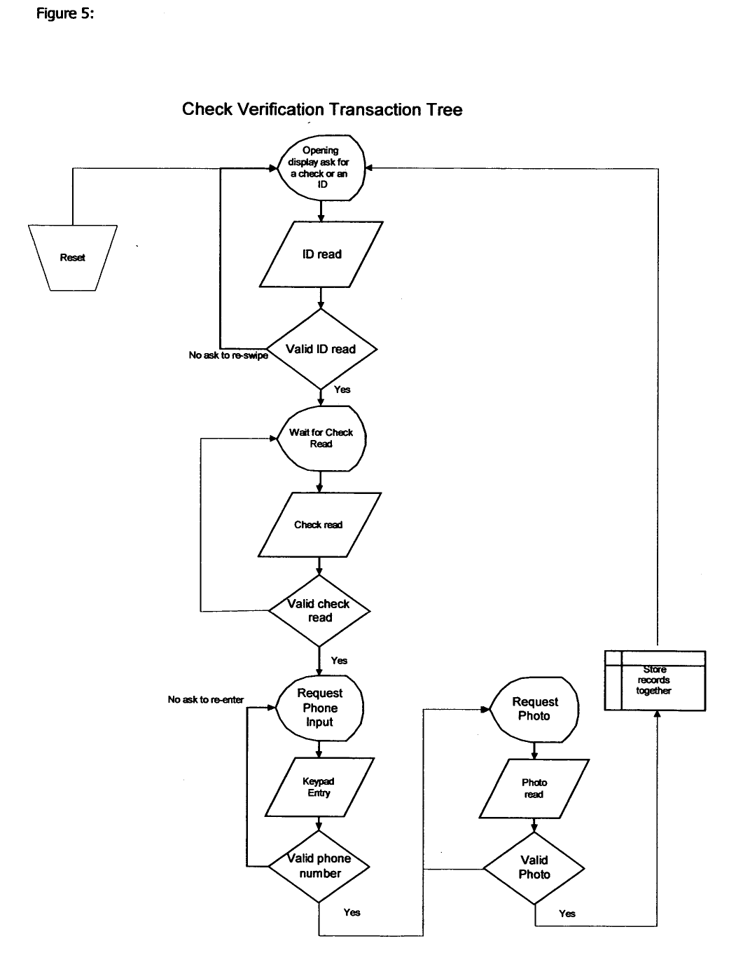

The card reader reside on the micro-controller 12C interface. The device stores all of the data from a single card read. Once the card read is complete the interface will set an interrupt for servicing the peripheral. The card reader has the capability of reading a three-stripe card. Once the interrupt is detected, the software reads, parses, and stores the data. If a check is read before or after the card read the drivers license data shall be stored with the check data. See FIG. 4 and FIG. 5 for the data reading sequencing and data storage for more information.

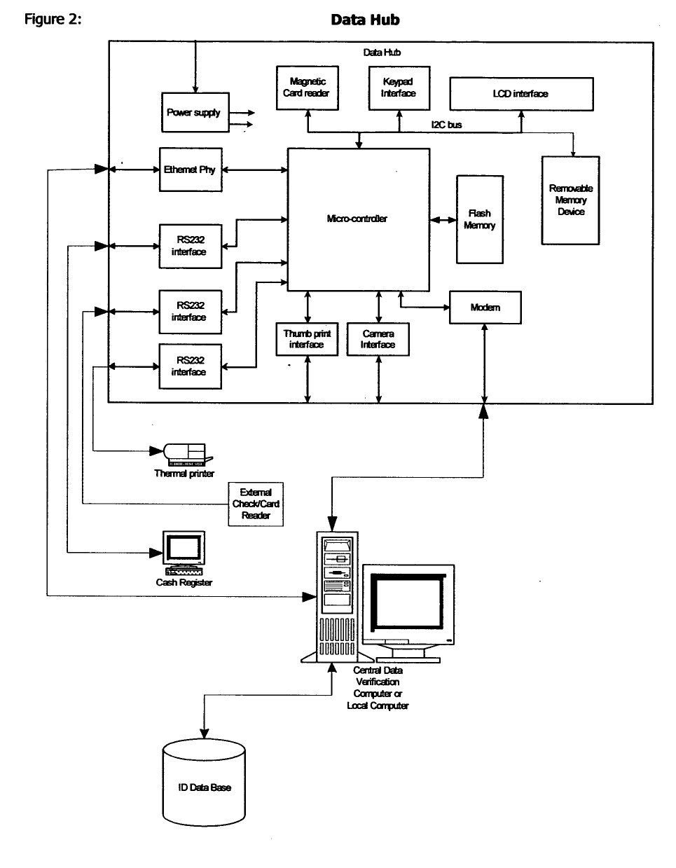

The LCD resides on a I2C interface and is used to display id information and user input data. The LCD I2C interface is slave only. See FIG. 2 for interface details.

The keypad resides on the micro-controller I2C interface. When a key is pressed the interface will record the key pressed and send an interrupt to the micro-controller. See FIG. 2 for the interface details.

The external check reader interfaces to the hub via a RS232 interface or an internal check reader interface via the I2C bus.

The thermal printer interface to the hub via a RS232 interface.

The system can support a host computer via a RS232 interface.

The purpose of this section is to describe the system works from the point of view of how a user would interface with the system.

Identification only mode. In this mode the data hub will be used to verify a person's age. The system shall have a real time clock, which will contain the current time and date, that will be used to calculate the patron's age.

Identification mode will keep track of whether or not this read is for age identification. External input is not required to determine the mode of the system. The mode is important to determine what data needs to be stored. When the system is in the identification mode it is not necessary to retain the drivers license data.

Age restrictions system will keep track of multiple separate age criteria to determine if it is legal for a patron to buy a product. These criteria will be entered on the system set up screen. These criteria are for cigarettes, alcohol, magazine, or other age-restricted items. This mode blocks the sale of such items through the interface (RS232 or Ethernet) to a cash register.

After the drivers license is read the system will display the person's name, age and two indicators saying whether or not it is OK to buy alcohol or cigarettes.

Check verification system will be used for check verification. In this mode the system shall record check information, driver license information, and phone number in a database that can be used at a later time.

Check verification transaction order system functions independently of check reads or driver's license reads. The patron can either swipe his drivers license first or do a check read.

After a check read the system will prompt the user to enter their phone number.

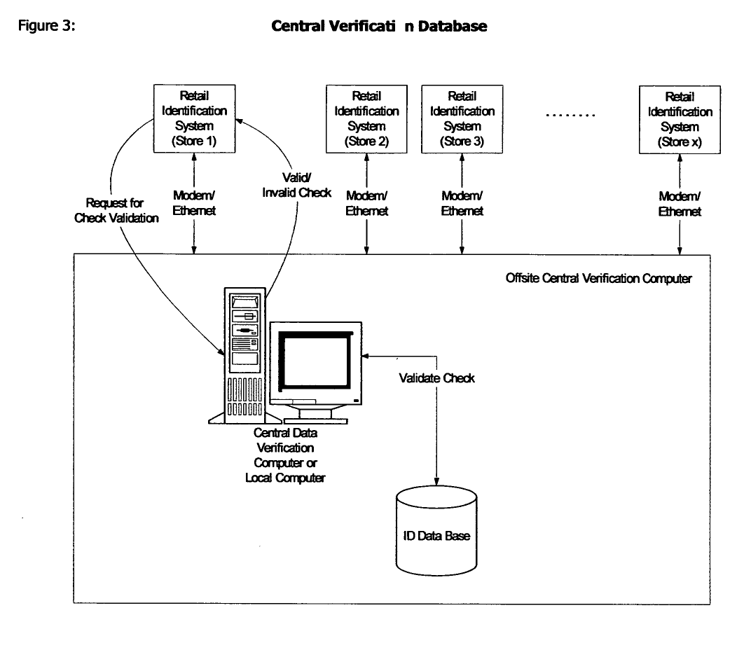

The check information, driver license, thumb print, photo, and phone number is stored in a manner that they can be retrieved as a unit. This data can be transmitted to a remote computer for further user processing via modem or Ethernet connection to a central database. This remote computer can determine if a check is to be accepted after validating against a central database, once validated the remote computer relays “valid” or “invalid” back to the Retail Identification System. This configuration is useful for business with more then one store or a group of businesses. See FIG. 3 for block diagram of this configuration.

Transaction tree of FIG. 4 and FIG. 5 describe how the sequence of events will occur during the check verification process.

When the system is in the neutral state and a driver license is swiped the system will display the information via the LCD. This information will be displayed and then return to the neutral state unless there is a check read or a push button has occurred to input a telephone number.

There are several ways the system can go into the check verification mode: the first is when a check read from the neutral state; the second is when a key is pressed to enter a telephone number; and, the third is when an ID is read and than a key is pressed, or a check is read.

In time card mode a driver license or employee ID is read that matches what is stored in memory the system shall record the time the swipe occurred. The time worked will be calculated and stored by subtracting the latest time read from the earliest time read. This data can be transmitted to a remote computer for further user processing via modem or Ethernet connection.

Administrator mode is entered through a host computer either through a serial interface or an Ethernet interface.

Switching the key on the data hub enters the print mode. This will force the system to print the check verification information and the time card information.

Security features of this system shall contain a unique ID number. This number shall be used to validate a host computer connecting to it. If the ID does not match the host computer the system will reject the connection.

Modem Interface is used by the software to send selected information to the destination recorded from the administration screen.

Removable memory (e.g. Memory Stick, Compact Flash) is used to transfer data from the device to a user PC.

1. A verification device for reading driver's licenses, bank checks, thumb prints, photos (from a digital camera), telephone numbers and storing this data in nonvolatile memory until down loaded to a variety of peripherals, said device comprising of:
an embedded microprocessor/microcontroller with on-board RAM/ROM used to store, process, and communicate information;
a card reader is a three stripe reader that has the capability of reading any state drivers license or credit cards;
a check reader that is able to read magnetically encoded checks;
a numeric keypad that will be used to input user data such as phone numbers;
a LCD display to convey user input as well as age validation;
a switch to change the state of the system to allow administrator privileges such as printing out a summary of checks cashed;
a thermal printer used to print hard copy of the information enter;
a thumb print reader used to associate finger print of customer with check;
a digital camera to photograph customer to be used in identifying customer with check;
an Ethernet connection to communicate with a host computer;
a modem used to communicate with a host computer;
a removable memory storage device with insertion slot to store data.
